(19) United States
(12) Patent Application Publication
(10) Pub. No.: US 2014/0369395 A1
(43) Pub. Date: Dec. 18, 2014

(54) Error Detection Based on Superheterodyne Conversion and Direct Downconversion

(71) Applicant: LSI Corporation, San Jose, CA (US)

(72) Inventor: Roger A. Fratti, Mohnton, PA (US)

(21) Appl. No.: 13/916,667

(22) Filed: Jun. 13, 2013

(51) Int. Cl. H04L 1/20

(52) U.S. Cl. CPC H04L 1/206
USPC 375/228

(57) ABSTRACT

In one embodiment, a radio receiver has a first downconverter, a second downconverter, first and second analog-to-digital converters, and an error detector. The first downconverter downconverts a received RF signal into a first baseband-frequency signal using a first downconversion technique, and the second downconverter downconverts the received signal into a second baseband-frequency signal using a second downconversion technique, different from the first downconversion technique. The first and second analog-to-digital converters convert the first and second baseband-frequency signals into first and second baseband digital signals, respectively. The error detection logic detects errors in at least one of the first and second baseband digital signals based on a comparison of the first baseband digital signal to the second baseband digital signal.

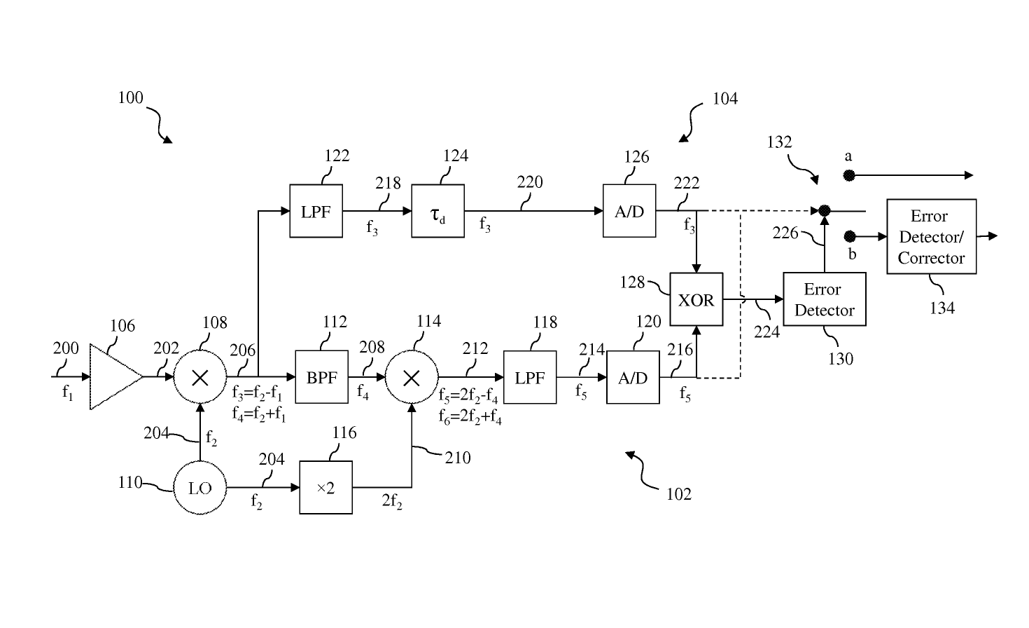

### BACKGROUND OF THE INVENTION

1. Field of the Invention

The present invention relates to communications, and, more specifically but not exclusively, to detecting errors in communicated signals.

2. Description of the Related Art

In a typical radio communication, a radio receiver receives and amplifies an incoming radio-frequency (RF) analog signal. The amplified RF signal is downconverted (i) from the radio frequency to an intermediate frequency (IF) and then to baseband frequency using, for example, a superheterodyne converter or (ii) from the radio frequency directly to the baseband frequency using, for example, a direct downconverter. After downconversion, the baseband analog signal is converted from analog format to digital format by an analog-to-digital converter.

In attempting to recover the transmitted information, errors can occur in any stage of the radio receiver. For example, suppose that a radio receiver receives, via an antenna, a weak signal that is near the noise floor, and that the noise is relatively stationary (e.g., white). The information and noise portions of the received signal are amplified by an amplifier that may have a noise figure that degrades the signal-to-noise ratio. The received signal may be further degraded as the received signal passes through the receiver and is eventually downconverted to the baseband frequency and sampled by the analog-to-digital converter. Any degradation along the signal path results in a corrupted signal that may cause an incorrect decision by the analog-to-digital converter.

### SUMMARY

In one embodiment, a radio receiver comprises first and second downconverters, first and second analog-to-digital converters, and error detection logic. The first downconverter is configured to downconvert a received signal into a first baseband-frequency signal using a first downconversion technique, and the second downconverter is configured to downconvert the received signal into a second baseband-frequency signal using a second downconversion technique, different from the first downconversion technique. The first and second analog-to-digital converters are configured to convert the first and second baseband-frequency signals to first and second digital signals, respectively. The error detection logic configured to detect errors in at least one of the first and second digital signals based on a comparison of the first digital signal to the second digital signal. In another embodiment, a radio receiver-implemented method implements the steps performed by the radio receiver described above.

### BRIEF DESCRIPTION OF THE DRAWING

Embodiments of the disclosure will become more fully apparent from the following detailed description, the appended claims, and the accompanying drawing, which shows a simplified block diagram of a receiver according to one embodiment of the disclosure.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The figure shows a simplified block diagram of a receiver 100 according to one embodiment of the disclosure. Receiver 100 may be implemented in a suitable wired or wireless communications systems, including, but not limited to, systems adhering to the Institute of Electrical and Electronics Engineers (IEEE) 802.15.4 standard and the Zigbee standard, and to low-power applications, including, but not limited to, applications employing the industrial, scientific, and medical (ISM) radio bands.

In general, receiver 100 amplifies an incoming analog radio-frequency (RF) signal. A first downconverter 102 upconverts the amplified analog RF signal to a higher frequency (HF) and then to the baseband frequency, and, in parallel, a second downconverter 104 downconverts the amplified analog RF signal directly to the baseband frequency (i.e., without going through any other frequency). First downconverter 102 may be, for example, an up/down or superheterodyne converter, and second downconverter 104 may be, for example, a direct, homodyne, synchrodyne, or zero-IF downconverter. The resulting baseband analog signals are converted to digital format in parallel using analog-to-digital converters 120 and 126, respectively, and the resulting digital signals are compared to one another to detect whether or not an error has occurred at the receiver resulting in an incorrect decision by at least one of the analog-to-digital converters. The errors occurring at receiver 100 may be caused by, for example, degradation in the incoming signal that is introduced by receiver 100 anywhere from the antenna through the analog-to-digital converters as described above. After the error detection, subsequent and different error detection and/or correction may optionally be performed as described below.

Referring now to the specific features of the figure, receiver 100 receives incoming signal 200 at a first frequency f₁ over a medium such as copper wire (e.g., a coaxial cable), fiber optic cable, or airwaves. For the following discussion, suppose as an example that incoming signal 200 is an RF analog signal transmitted over the 2.4 GHz ISM band (i.e., f₁=2.4 GHz). Incoming signal 200 is amplified by amplifier 106, and amplified RF signal 202 is downconverted in parallel by the first and second downconverters 102 and 104.

The first downconverter 102 (i.e., the downconverter that upconverts the incoming RF signal to a higher frequency and then to the baseband frequency) comprises local oscillator (LO) 110, frequency mixer 108, band-pass filter (BPF) 112, multiplier 116, frequency mixer 114, low-pass filter (LPF) 118, and analog-to-digital (A/D) converter 120. In operation, frequency mixer 108 mixes amplified RF signal 202 with LO signal 204 that is generated by local oscillator 110 and has frequency f₂. The resulting mixed signal 206 has lower-frequency component f₃, which is the difference between frequencies f₂ and f₁ (i.e., f₃=f₂−f₁) and higher-frequency component f₄, which is the summation of frequencies f₂ and f₁ (i.e., f₄=f₂+f₁). Thus, continuing the example from above, if f₂=2.8 GHz, then f₃=2.8 GHz−2.4 GHz=0.4 GHz, and f₄=2.8 GHz+2.4 GHz=5.2 GHz.

Band-pass filter 112 filters mixed signal 206 to pass higher-frequency component f₄ and attenuate lower-frequency component f₃. The resulting filtered signal 208 is mixed with 2×LO signal 210, which is generated by multiplier 116 doubling the frequency f₂ of the LO signal 204. The resulting mixed signal 212 has lower-frequency (i.e., baseband-frequency) component f₅, which is the difference between frequencies 2×f₂ and f₄ (i.e., f₅=2×f₂−f₄) and higher-frequency component f₆, which is the summation of frequencies 2×f₂ and f₄ (i.e., f₆=2×f₂+f₄). Thus, continuing the example from above, f₅=2×2.8 GHz−5.2 GHz=0.4 GHz, and f₆=2×2.8 GHz+5.2 GHz=10.8 GHz.

Low-pass filter 118 filters mixed signal 212 to pass baseband-frequency component f₅ and attenuate higher-frequency component f₆, and the resulting baseband analog signal 214 is converted into digital format by analog-to-digital converter 120.

The second downconverter (i.e., the downconverter that downconverts the incoming RF signal directly to the baseband frequency) shares local oscillator 110 and frequency mixer 108 with first downconverter 102 and further comprises low-pass filter 122, time delay 124, and A/D converter 126. Using a single local oscillator 110, and sharing that local oscillator along with frequency mixer 108 reduces the area and power requirements of receiver 100. In operation, low-pass filter 122 filters mixed signal 206 to pass baseband frequency component f₃ (e.g., 0.4 GHz) and attenuate higher-frequency component f₄ (e.g., 5.2 GHz). Filtered signal 218 is delayed by time delay 124 such that, when analog-to-digital converter 126 converts delayed baseband signal 220 into digital downconverted signal 222, the bits of digital down-converted signal 222 correspond in time with (i.e., a synchronized with) the corresponding bits of digital downconverted signal 216.

Exclusive-or (XOR) logic 128 compares the bits of digital baseband signal 222 to the corresponding bits of digital baseband signal 216 on a bit-by-bit basis, and makes bit-by-bit decisions to generate error signal 224, which indicates whether or not one or more errors are detected. Each time that the corresponding bits match, XOR logic 128 outputs a value of zero into error signal 224, indicating that no error is detected for the bit pair, and each time that the corresponding bits disagree, XOR logic 128 outputs a value of one into error signal 224, indicating that an error is detected for the bit pair.

Error detector 130 receives error signal 224, comprising the bit-by-bit error decisions, and generates a hard error decision 226 for an entire set of data (e.g., for an entire codeword of error-correction encoded or error-detection encoded data). If error detector 130 does not detect an error in error signal 224 for the entire set of data (i.e., the entire sets of data are identical), then error detector 130 generates the hard error decision 226 to operate switch 132 in position “a”. In this case, the data is provided downstream to the user application and no further error detection and/or correction processing (e.g., 134) is performed downstream for that set of data. In fact, the processing related to any downstream error detection and/or correction may be turned off to conserve power until an error is detected.

If error detector 130 detects at least one error in error signal 224 for an entire set of data, then error detector 130 generates the hard error decision 226 to operate switch 132 in position “b”. In this case, a subsequent and different error detection and/or correction processing 134 is performed downstream to detect the locations of the errors, and possibly correct those errors. Note that the subsequent and different error detection and/or correction processing 134 may detect and/or correct errors that arise from the antenna through analog-to-digital converters 120 and 126. Further, the subsequent and different error detection and/or correction processing 134 may also be capable of detecting and/or correcting errors that occur due to transmitting a signal over a transmission channel, including, but not limited to, soft-error detection and/or correction (e.g., Viterbi detection) and/or cyclic-redundancy check (CRC) error detection. The subsequent error detection and/or correction processing 134 may continue to operate on further sets of data (e.g., further codewords) until error detector 130 detects that no errors are present in a subsequent set of data (e.g., in a subsequent codeword).

Note that the hard error detection performed by XOR logic 128 and error detector 130 may consume less power, may be less computationally complex, and may introduce shorter latencies than the error detection and/or correction techniques used by error detection and/or correction processing 134. Thus, power may be conserved and latencies may be reduced when XOR logic 128 and error detector 130 are used in lieu of error detection and/or correction processing 134.

As described above, error detector 130 detects errors that may occur in receiver 100 from the antenna through analog-to-digital converters 120 and 126, and not errors that occur over the transmission medium. Therefore, error detector 130 may be particularly useful, for example, when the transmission link is relatively reliable or when a low data rate is employed that is less susceptible to demodulation errors (e.g., using quadrature phase-shift keying (QPSK) modulation instead of 16 quadrature-amplitude modulation (QAM)).

Although an embodiment of the disclosure has been described as having a comparator that implements XOR logic 128, embodiments of disclosure are not so limited. Alternative embodiments of the disclosure may have comparators that implement logic other than XOR logic, such as exclusive-nor (XNOR) logic. Further, alternative embodiments of the disclosure may have comparators that perform comparisons on a basis greater than a bit-by-bit basis, such as on a sample-by-sample basis or a symbol-by-symbol basis.

Further, although an embodiment of the disclosure has been described as having a single local oscillator 110 that is shared between two downconverters, embodiments of the disclosure are not so limited. According to alternative embodiments of the disclosure, receivers of the disclosure may implement more than one local oscillator for the first and second downconverters. For example, mixer 114 could be fed by a second local oscillator (not shown) that generates signal 210 at frequency 2×f₂, thereby eliminating the need for multiplier 116. As another example, each downconverter may implement its own local oscillator or oscillators and/or its own mixer or mixers.

Yet further, although an embodiment of the disclosure was described as having (i) a first downconverter 102 that upconverts a received signal to higher frequency and downconverts the higher-frequency signal to the baseband frequency, and (ii) a second downconverter 104 that downconverts the received signal directly to the baseband frequency, embodiments of the disclosure are not so limited. According to alternative embodiments, receivers of the disclosure may be implemented using any combination of two different downconversion techniques. For example, first downconverter 102 may downconvert the received signal to an intermediate frequency (IF), rather than a higher frequency, before downconverting the received signal to the baseband frequency. As another example, the first and the second downconverters may both upconvert the received signal (or downconvert the received signal) before ultimately downconverting the received signal to the baseband frequency such that the first and second downconverters upconvert the received signal to different higher frequencies (or downconvert to different intermediate frequencies). As even yet another example, one downconverter may upconvert the received signal to a higher frequency before downconverting the signal to the baseband frequency, while the other downconverter downconverts the received signal to an intermediate frequency before downconverting the signal to the baseband frequency.

Even yet further, although an embodiment of the disclosure was described performing subsequent error detection and/or correction processing 134 only when error detector 130 detects an error, embodiments of the disclosure are not so limited. According to alternative embodiments of the disclosure, error detection and/or correction 134 may be performed when error detector 130 does not detect an error, thereby providing an extra layer of error detection. In addition, in some implementations, receivers of the disclosure may be implemented without subsequent error detection and/or correction processing 134, such that subsequent error detection and/or correction processing 134 is never performed.

Even still further, although an embodiment of the disclosure has been described as having two parallel downconverters and two parallel analog-to-digital converters, embodiments of the disclosure are not so limited. According to alternative embodiments, receivers of the disclosure may have more than two parallel downconverters and more than two parallel analog-to-digital converters that generate more than two digital baseband signals. In these alternative embodiments, the more than two digital baseband signals may be compared to generate the error decision.

It will be further understood that various changes in the details, materials, and arrangements of the parts which have been described and illustrated in order to explain the nature of this invention may be made by those skilled in the art without departing from the scope of the invention as expressed in the following claims. For example, one would understand that delay element 124 could be implemented between analog-to-digital converter 126 and XOR logic 128 or upstream of LPF 122.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A radio receiver comprising:
a first downconverter configured to downconvert a received signal into a first baseband-frequency signal using a first downconversion technique;
a second downconverter configured to downconvert the received signal into a second baseband-frequency signal using a second downconversion technique, different from the first downconversion technique;
first and second analog-to-digital converters configured to convert the first and second baseband-frequency signals to first and second digital signals, respectively; and
error detection logic configured to detect errors in at least one of the first and second digital signals based on a comparison of the first digital signal to the second digital signal.

2. The radio receiver of claim 1, wherein the first downconversion technique comprises downconverting the received signal to a higher-frequency signal or intermediate-frequency signal before downconverting the received signal into the first baseband-frequency signal.

3. The radio receiver of claim 2, wherein the second downconversion technique comprises downconverting the received signal directly to the second baseband-frequency signal.

4. The radio receiver of claim 2, wherein the second downconversion technique comprises downconverting the received signal to another higher-frequency signal or another intermediate-frequency signal having a frequency different from the higher-frequency signal or the intermediate-frequency signal before downconverting the received signal into the second baseband-frequency signal.

5. The radio receiver of claim 1, wherein the second downconversion technique comprises downconverting the received signal directly to the second baseband-frequency signal.

6. The radio receiver of claim 1, wherein the first downconverter and the second downconverter share a local oscillator.

7. The radio receiver of claim 1, wherein the error detection logic is configured to perform a bit-by-bit comparison of the first digital signal to the second digital signal.

8. The radio receiver of claim 7, wherein the error detection logic comprises XOR logic configured to perform the bit-by-bit comparison.

9. The radio receiver of claim 7, wherein the error detection logic is configured to generate an error decision based on a plurality of bit-by-bit comparisons.

10. The radio receiver of claim 1, further comprising one or both of (i) a subsequent and different error detector and (ii) an error corrector configured to perform subsequent and different error detection and error correction, respectively.

11. The radio receiver of claim 10, wherein, if the error detection logic detects an error, then one or both of (i) the subsequent and different error detection and (ii) the error correction is performed.

12. The radio receiver of claim 10, wherein, if the error detection logic does not detect an error, then one or both of (i) the subsequent and different error detection and the error correction is performed.

13. A radio-receiver implemented method comprising:
(a) downconverting a received signal into a first baseband-frequency signal using a first downconversion technique;
(b) downconverting the received signal into a second baseband-frequency signal using a second downconversion technique, different from the first downconversion technique;
(c) converting the first and second baseband-frequency signals to first and second digital signals, respectively; and
(d) detecting errors in at least one of the first and second digital signals based on a comparison of the first digital signal to the second digital signal.

14. The radio-receiver implemented method of claim 13, wherein step (a) comprises downconverting the received signal to a higher-frequency signal or intermediate-frequency signal before downconverting the received signal into the first baseband-frequency signal.

15. The radio-receiver implemented method of claim 14, wherein step (b) comprises downconverting the received signal directly to the second baseband-frequency signal.

16. The radio-receiver implemented method of claim 14, wherein step (b) comprises downconverting the received signal to another higher-frequency signal or another intermediate-frequency signal having a frequency different from the higher-frequency signal or the intermediate-frequency signal before downconverting the received signal into the second baseband-frequency signal.

17. The radio-receiver implemented method of claim 13, wherein step (b) comprises downconverting the received signal directly to the second baseband-frequency signal.

18. The radio-receiver implemented method of claim 13, wherein steps (a) and (b) are implemented using a shared local oscillator.

19. The radio-receiver implemented method of claim 13, wherein step (d) comprises performing a bit-by-bit comparison of the first digital signal to the second digital signal.

20. The radio-receiver implemented method of claim 13, further comprising (e) performing one or both of (i) subsequent and different error detection and (ii) error correction.
